(19) United States
(12) Patent Application Publication
(10) Pub. No.: US 2024/0193953 A1
(43) Pub. Date: Jun. 13, 2024

(54) INFORMATION PROCESSING METHOD, INFORMATION PROCESSING DEVICE, AND PROGRAM

(71) Applicant: Sony Semiconductor Solutions Corporation, Kanagawa (JP)

(72) Inventors: Genta Matsukawa, Kanagawa (JP); Ryuji Takehara, Chiba (JP)

(21) Appl. No.: 18/554,331

(22) PCT Filed: Jan. 13, 2022
(86) PCT No.: PCT/JP2022/000887

§ 371 Date: Oct. 6, 2023

(30) Foreign Application Priority Data
May 6, 2021 (JP) 2021-078361

(51) Int. Cl. G06V 20/52; G06Q 10/0639; G06V 10/25; G06V 20/70

(52) U.S. Cl. CPC G06V 20/52; G06Q 10/06398; G06V 10/25; G06V 20/70

(57) ABSTRACT

[Problem] To propose an information processing method, an information processing device, and a program that are new and are modified to enable to improve the workability of an annotation work performed by a labeling operator.

[Solution] An information processing method performed by a computer, the method including: attaching a first information tag to a target segment of video data on the basis of the video data obtained by capturing a video of a worker and an evaluation model, the first information tag relating to a factory work; and generating first display information including a second information tag and the first information tag on the same time line of the video data, the second information tag relating to the factory work and being attached to a segment by a user, the first information tag being attached to the target segment.

### TECHNICAL FIELD

The present disclosure relates to an information processing method, an information processing device, and a program.

### BACKGROUND ART

Techniques for attaching information tags to input data such as image data and video data by using a machine learning technique have been developed in recent years. In such a technique for attaching information tags by using a machine learning technique, a labeling operator needs to produce an estimator by learning using sets of input data and information tags as teacher data.

Moreover, the labeling operator desirably confirms an information tag attached to input data by an estimator and improves, when the degree of accuracy is assumed to be lower than expected, the estimator by relearning according to teacher data after correcting an information tag included in the teacher data.

In some cases, a work for producing such an estimator and attaching an information tag for a correction by a labeling operator is represented as an annotation work. An annotation work depends upon the experience and intuition of a labeling operator, so that the working efficiency may vary depending upon the labeling operator. For example, PTL 1 discloses a technique of calculating the accuracy of an annotation work of a labeling operator on the basis of a comparison between an information tag attached by a correction made by the labeling operator and an information tag prepared in advance as correct data.

### CITATION LIST

### Patent Literature

### [PTL 1]

WO 2019/187421

### SUMMARY

### Technical Problem

In the technique described in PTL 1, however, the annotation skill of a labeling operator can be recognized but it is difficult for an unskilled labeling operator to accurately perform an annotation work.

Thus, the present disclosure proposes an information processing method, an information processing device, and a program that are new and are modified to enable to improve the workability of an annotation work performed by a labeling operator.

### Solution to Problem

The present disclosure provides an information processing method performed by a computer, the method including: attaching a first information tag to a target segment of video data on the basis of the video data obtained by capturing a video of a worker and an evaluation model, the first information tag relating to a factory work; and generating first display information including a second information tag and the first information tag on the same time line of the video data, the second information tag relating to the factory work and being attached to a segment by a user, the first information tag being attached to the target segment.

The present disclosure also provides an information processing device including a control unit that attaches a first information tag to a target segment of video data on a basis of the video data obtained by capturing a video of a worker and an evaluation model, the first information tag relating to a factory work, and generates first display information including a second information tag and the first information tag on the same time line of the video data, the second information tag relating to the factory work and being attached to a segment by a user, the first information tag being attached to the target segment.

The present disclosure also provides a program that causes a computer to implement an attaching function of attaching a first information tag to a target segment of video data on the basis of the video data obtained by capturing a video of a worker and an evaluation model, the first information tag relating to a factory work; and a generating function of generating first display information including a second information tag and the first information tag on the same time line of the video data, the second information tag relating to the factory work and being attached to a segment by a user, the first information tag being attached to the target segment.

### BRIEF DESCRIPTION OF DRAWINGS

FIG. 1 is an explanatory drawing illustrating an example of an information processing system according to the present disclosure.

FIG. 2 is an explanatory drawing illustrating a functional configuration example of an information processing device 30 according to the present disclosure.

FIG. 3 is an explanatory drawing illustrating an example of a setting screen UD1 for learning and evaluation.

FIG. 4 is an explanatory drawing illustrating an example of an execution screen UD2 for learning and evaluation.

FIG. 5 is an explanatory drawing illustrating an evaluation result display screen UD3 according to the present disclosure.

FIG. 6 is an explanatory drawing illustrating a performance index display D2 according to the present disclosure.

FIG. 7 is an explanatory drawing illustrating a detailed display D3 of a performance index according to the present disclosure.

FIG. 8 is an explanatory drawing illustrating an example of a report display screen UD4 including the result of inference according to the present disclosure.

FIG. 9 is an explanatory drawing illustrating an operation processing example of the information processing device 30 according to the present disclosure.

FIG. 10 is a block diagram illustrating the hardware configuration of the information processing device 30.

### DESCRIPTION OF EMBODIMENTS

A preferred embodiment of the present disclosure will be described in detail with reference to the accompanying drawings. Also, in the present specification and the figures, components having substantially the same functional configurations will be denoted by the same reference numerals, and thus repeated descriptions thereof will be omitted.

In addition, “Description of Embodiment” will be described in accordance with the following order of items.
1. Overview of Information Processing System
2. Exemplary Functional Configuration of Information Processing Device 30
3. Background and Overall Perspective
4. Specific Example of User Interface
4.1. Presetting for Creation of Learned Model
4.2. Performing Learning and Evaluation
4.3. Evaluation Result Display Screen
4.4. Performance Index Information
4.5. Detailed Information About Performance Index
4.6. Result of Inference
5. Operation Processing Example
6. Example of Operation and Effect
7. Hardware Configuration Example
8. Supplements

### 1. Overview of Information Processing System

As an embodiment of the present disclosure, a mechanism for improving the workability of an annotation work depending upon the experience and intuition of a user will be described below.

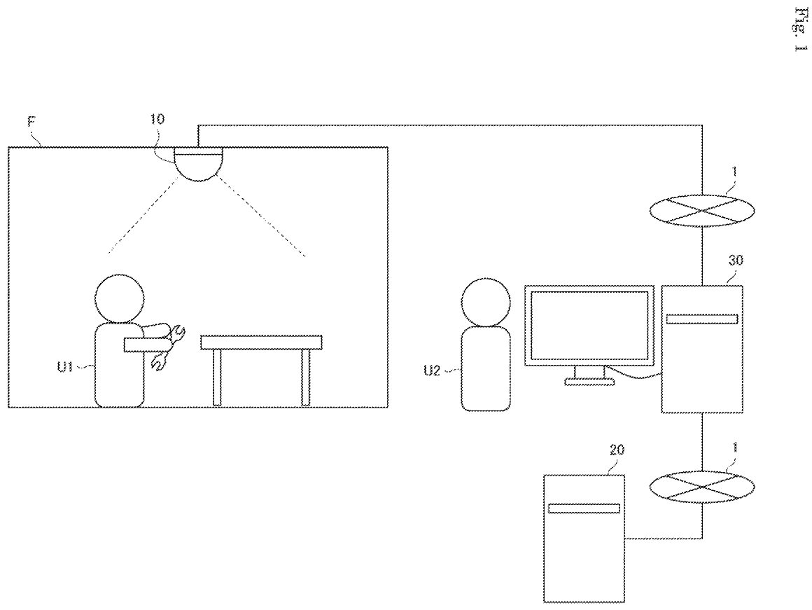

FIG. 1 is an explanatory drawing illustrating an example of an information processing system according to the present disclosure. The information processing system according to the present disclosure includes a network 1, an imaging device 10, a server 20, and an information processing device 30.

### (Network 1)

The network 1 is a wired or wireless transmission line for information transmitted from devices connected to the network 1. For example, the network 1 may include public networks such as the Internet, a telephone network, and a satellite communication network, various LANs (Local Area Networks) including Ethernet (registered trademark), and a WAN (Wide Area Network). Moreover, the network 1 may include leased line networks such as an IP-VPN (Internet Protocol-Virtual Private Network).

The imaging device 10 and the information processing device 30 are connected each other and the server 20 and the information processing device 30 are connected to each other via the network 1.

### (Imaging Device 10)

The imaging device 10 captures a video of a subject and acquires video data including a video of the subject. In the example of FIG. 1, the imaging device 10 is installed in a factory F, captures a video of a worker U1 working in the factory F and acquires video data including the video of the worker U1.

Moreover, the imaging device 10 transmits the video data obtained by capturing the video of the worker U1, to the information processing device 30 via the network 1.

### (Server 20)

The server 20 monitors the registration of various devices and the operations of applications. Moreover, the server 20 keeps data in a permanent condition by holding various kinds of information including past video data and setting information. For example, the server 20 may be a cloud server.

### (Information Processing Device 30)

The information processing device 30 is a device used by a labeler U2 in charge of attaching an information tag. The labeler U2 is an example of a user of the present disclosure.

For example, on the basis of video data acquired by the imaging device 10 and a learned model as an example of an evaluation model, the information processing device 30 attaches an information tag for a factory work to a target segment of the video data. In the present specification, an information tag attached on the basis of a learned model may be represented as a model tag. Moreover, in the present specification, a learned model will be mainly described as an example of the evaluation model. The evaluation model of the present disclosure is not limited to this example. For example, the evaluation model may be a rule-based method or a method using a statistical analysis or may be a program implemented by combining a plurality of learned models or rules.

In the present specification, video data used for generating a learned model may be represented as learning video data and video data used for evaluating a learned model may be represented as evaluation video data. The evaluation video data is an example of video data, and the learning video data is an example of another video data.

The information processing device 30 generates, for example, display information including an information tag attached by the labeler U2 and a model tag, for evaluation video data. An information tag attached by the labeler U2 may be represented as a labeler tag. A labeler tag attached to evaluation video data is an example of a second information tag, and a labeler tag attached to learning video data is an example of a third information tag.

In the following example, a PC (Personal Computer) is mainly used as the information processing device 30 according to the present disclosure. The information processing device 30 may be, for example, a smartphone or a tablet.

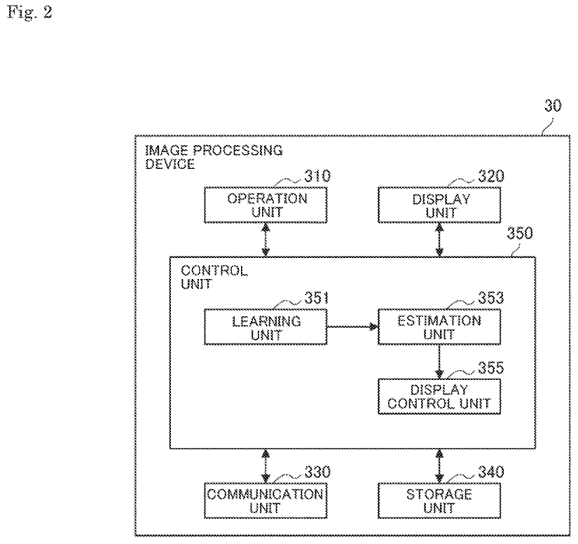

Referring to FIG. 2, a functional configuration example of the information processing device 30 according to the present disclosure will be described below.

### 2. Functional Configuration Example of Information Processing Device 30

FIG. 2 is an explanatory drawing illustrating a functional configuration example of the information processing device 30 according to the present disclosure. As illustrated in FIG. 2, the information processing device 30 according to the present disclosure includes an operation unit 310, a display unit 320, a communication unit 330, a storage unit 340, and a control unit 350.

### (Operation Unit 310)

The operation unit 310 receives an operation input by the labeler U2. For example, the operation unit 310 performs various operations for an annotation work in response to an operation of the labeler U2. For example, the operation unit 310 receives information about the working process of the worker U1 from the labeler U2. The functions of the operation unit 310 may be implemented by a mouse, a keyboard, or a touch panel.

### (Display Unit 320)

The display unit 320 displays various kinds of display information generated by a display control unit 355, which will be described later. The function of the display unit 320 may be implemented by a CRT (Cathode Ray Tube) display device, a liquid crystal display (LCD) device, or an OLED (Organic Light Emitting Diode) device.

### (Communication Unit 330)

The communication unit 330 performs various communications with the imaging device 10 or the server 20. For example, the communication unit 330 receives video data, which is obtained by capturing a video of the worker U1 working in a factory, from the imaging device 10.

### (Storage Unit 340)

The storage unit 340 holds software and various kinds of data. For example, the storage unit 340 holds video data received by the communication unit 330. Moreover, the storage unit 340 holds learning video data and evaluation video data with labeler tags attached by the labeler U2 and evaluation video data with a model tag attached by an estimation unit 353.

### (Control Unit 350)

The control unit 350 controls the overall operations of the information processing device 30 according to the present disclosure. As illustrated in FIG. 2, the control unit 350 according to the present disclosure includes a learning unit 351, the estimation unit 353, and the display control unit 355.

### (Learning Unit 351)

The learning unit 351 generates a learned model according to a machine learning technique in which a set of learning video data and a labeler tag serves as teacher data.

For example, the labeler U2 attaches an information tag (labeler tag), which relates to a work in the factory F, to a time segment of video data obtained by capturing a video of the worker U1 working in the factory F. The learning unit 351 then generates a learned model according to a machine learning technique in which a set of learning video data and the labeler tag serves as teacher data.

When the labeler tag of evaluation video data is corrected according to comparison display information, which will be described later, the learning unit 351 relearns a set of the corrected labeler tag and the evaluation video data as new learning video data and updates the learned model.

### (Estimation Unit 353)

On the basis of the learned model obtained by the learning unit 351, the estimation unit 353 attaches a model tag to a target segment of evaluation video data obtained by capturing a video of the worker U1 working in the factory.

Moreover, on the basis of the learned model obtained by the learning unit 351, the estimation unit 353 attaches a model tag to a target segment of video data, which is registered to be inferred, other than learning video data and evaluation video data.

### (Display Control Unit 355)

The display control unit 355 controls the display of display information by the display unit 320. For example, the display control unit 355 generates comparison information that indicates a labeler tag and a model tag in contrast on the same time line of evaluation video data and causes the display unit 320 to display a screen including the comparison information. The detail of the comparison information will be described later.

The functional configuration example of the information processing device 30 according to the present disclosure was described above. The background and overall perspective of the present disclosure will be described below.

### 3. Background and Overall Perspective

As described above, on the basis of the learned model obtained by the learning unit 351, the estimation unit 353 attaches a model tag to a target segment of video data registered to be inferred.

In other words, whether the estimation unit 353 is to attach a desired model tag to a segment requested by the labeler U2 can be determined according to the accuracy of the learned model. In order to improve the accuracy of the learned model, the labeler U2 may perform a re-annotation work for improving the learned model as necessary in addition to an annotation work for creating the learned model.

Such a re-annotation work includes a work depending upon the experience and intuition of the labeler U2, so that working efficiency for an improvement of the learned model may vary depending upon the skill of the labeler U2. The overall perspective of an annotation work required for creating and improving the learned model according to the embodiment of the present disclosure will be described below.

First, the labeler U2 performs an operation input for the creation of a learned model by using the operation unit 310 with reference to a display screen displayed on the display unit 320.

When the learned model is created, the labeler U2 first prepares teacher data as a set of learning video data and a labeler tag by attaching an information tag to the learning video data.

Moreover, the labeler U2 prepares evaluation video data for evaluating the estimated accuracy of the learned model to be created. The labeler U2 also attaches the labeler tag in advance to the evaluation video data.

The learning unit 351 then generates the learned model through learning using the teacher data prepared by the labeler U2. Furthermore, on the basis of the evaluation video data and the generated learned model, the learning unit 351 attaches a model tag to a target segment of the evaluation video data.

The display control unit 355 then causes the display unit 320 to display a comparison information screen including the labeler tag, which is attached by the labeler U2, and the model tag, which is attached by the estimation unit 353, on the same time line of the evaluation video data.

Thus, the labeler U2 can confirm a comparison between the information tag attached to the evaluation video data by the labeler U2 and the information tag attached by the estimation unit 353, thereby determining whether the estimation unit 353 has attached the model tag with accuracy requested by the labeler U2.

If the estimation unit 353 has not attached a desired model tag to a segment requested by the labeler U2, the labeler U2 performs an operation for correcting the labeler tag included in the evaluation video data.

The operation for improving the learned model is repeated by the labeler U2 until the learned model has desired accuracy, allowing the estimation unit 353 to make an inference with higher accuracy.

The background and overall perspective of the present disclosure was described above. Subsequently, an example of a UI display screen for various operations from the creation of the learned model to the inference will be described below.

### 4. Specific Example of User Interface

### <<4.1. Presetting for Creation of Learned Model>>

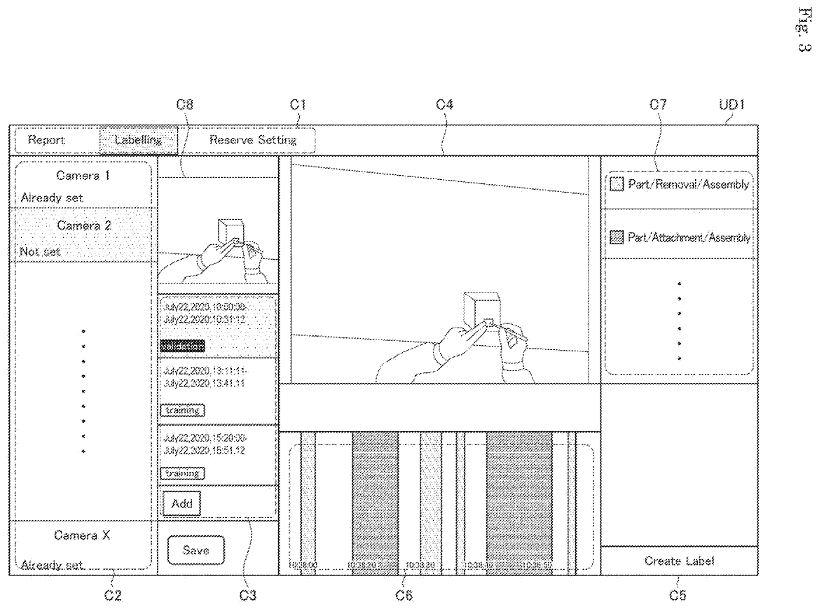

FIG. 3 is an explanatory drawing illustrating an example of a setting screen UD1 for learning and evaluation. As illustrated in FIG. 3, the setting screen UD1 for learning and evaluation according to the present disclosure may include, for example, a main category C1, an imaging device selection field C2, a video data registration field C3, a video data display screen C4, an information tag addition button C5, and a labeler tag attachment section C6, an information tag selection field C7, and a Crop information display field C8.

As shown in FIG. 3, the main category C1 includes, for example, a “Report” button, a “Labelling” button, and a “Reserve Setting” button.

When the “Report” button is selected by the labeler U2, the display unit 320 displays the result of inference, which will be described later.

When the “Labelling” button is selected by the labeler U2, as shown in FIG. 3, the display unit 320 displays a setting screen for generating and evaluating a learned model.

When the “Reserve Setting button” is selected by the labeler U2, the display unit 320 displays a display screen for learning or inference, which will be described later.

The imaging device selection field C2 includes a list of imaging devices 10 that are candidates to be attached with an information tag by the labeler U2.

For example, if a learning model corresponding to “camera 2” is created, the labeler U2 selects “camera 2.” Alternatively, when the labeler U2 completes a series of operations of attaching information tags to learning video data and evaluation video data for “camera 2,” the display control unit 355 may switch markings from “Not set” to “Alredy set” on the cameras included in the imaging device selection field C2. Thus, the labeler U2 can more easily determine whether presetting has been completed for each of the imaging devices 10. In the following example, the labeler U2 selects “camera 2” in FIG. 3.

The video data registration field C3 includes a list of learning video data and evaluation video data about the imaging device (e.g., camera 2) selected by the labeler U2 in the imaging device selection field C2.

For example, when the “Add” button is selected by the labeler U2, a setting for a new registration of video data is started. The labeler U2 then specifies a time range captured by the camera 2 and selects whether video data in the time range is to be registered for “learning” or “evaluation,” which completes the registration of the video data. In the example of FIG. 3, the display control unit 355 displays a marking of “training” for a video data field registered as “learning” and displays a marking of “validation” for a video data field registered as “evaluation.”

At least one segment of video data needs to be registered as learning video data and evaluation video data. It is desirable to register two or more segments of learning video data. In the following example, the labeler U2 selects video data of validation in FIG. 3.

The video data display screen C4 is a screen for reproducing video data selected in the video data registration field C3.

The information tag addition button C5 is a button for adding a new information tag. The labeler U2 selects the information tag addition button C5 and inputs the name of an information tag to be added (e.g., “Part/Removal/Assembly”), so that the information tag is added in the information tag selection field C7. The labeler U2 may input the category of an information tag (e.g., “pretreatment,” “assembly,” or “disassembly”) in addition to the name of the information tag.

The labeler tag attachment section C6 includes an area where the labeler U2 attaches an information tag to video data selected in the video data registration field C3.

For example, the labeler U2 specifies a time segment for attaching an information tag, from among pieces of video data selected in the video data registration field C3. More specifically, the labeler U2 may input a start time and a finish time to specify a time segment for attaching an information tag, or operate a mouse to specify a time segment for attaching an information tag. The time segment specified by the labeler U2 corresponds to a hatched section in FIG. 3. Until the labeler U2 allocates an information tag, the section may be displayed in a color (e.g., white) indicating the absence of an allocated information tag.

The information tag selection field C7 includes a list of information tags added in the information tag addition button C5.

For example, the labeler U2 applies an information tag included in the information tag selection field C7 to a time segment specified in the labeler tag attachment section C6. More specifically, the labeler U2 may perform a drag-and-drop operation to apply an information tag included in the information tag selection field C7 to a time segment of the labeler tag attachment section C6. As in a hatched section of FIG. 3, the color of a section allocated with an information tag may be changed to a color corresponding to the information tag.

The Crop information display field C8 is a display field for specifying a target area of video data used for learning and evaluation from among pieces of learning video data and evaluation video data. If a target area is not specified in the Crop information display field C8, an overall image included in the video data display screen C4 corresponds to a target area.

The example of the setting screen UD1 for learning and evaluation was described above. The presetting for learning and evaluation according to the present disclosure is not limited to this example.

For example, the labeler U2 may input information about the working process of the worker U1. Thus, the estimation unit 353 can estimate that a segment irrelevant to the working process is a segment not to be attached with an information tag on the basis of a learned model obtained by learning and the information about the working process. The information about the working process may be a work procedure manual prepared for each work in a factory or information about factory equipment (e.g., a robot, a jig, or an electric tool) used by the worker U1.

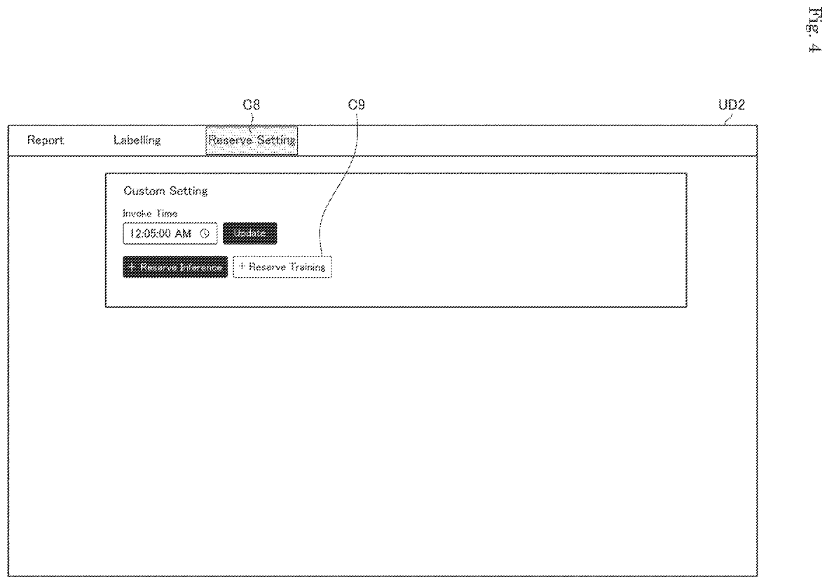

Referring to FIG. 4, a UI for performing learning and evaluation by using teacher data preset by the labeler U2 will be described below.

### <<4.2. Performing Learning and Evaluation>>

FIG. 4 is an explanatory drawing of an example of an execution screen UD2 for learning and evaluation. First, the execution screen UD2 for learning and evaluation is displayed when the labeler U2 selects a Reserve Setting button C8.

The labeler U2 selects a learning reservation (Reserve Training) button C9 and selects the imaging device 10 for performing learning and evaluation.

When the learning reservation button C9 is selected, the learning unit 351 performs learning on the basis of teacher data (learning video data attached with an information tag). Thereafter, on the basis of a learned model obtained by the learning, the estimation unit 353 attaches an information tag to the evaluation video data.

A time when learning and evaluation are performed may be specified by the labeler U2. For example, if a time for performing learning and evaluation is inputted in a “Invoke Time” field in FIG. 4, the learning unit 351 starts learning based on teacher data at the time.

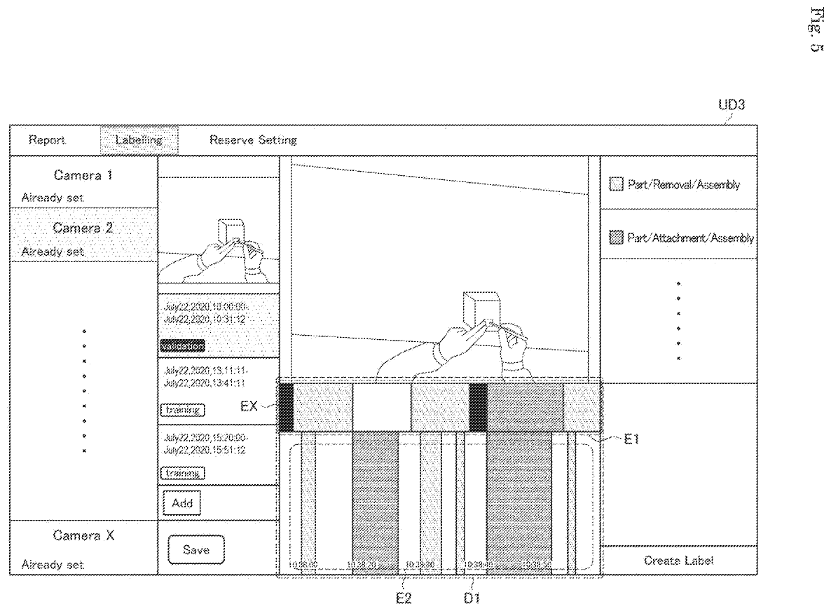

The display screen for learning and evaluation according to the present disclosure was described above. Referring to FIG. 5, an example of the result of evaluation using evaluation video data will be described below.

### <<4.3. Evaluation Result Display Screen>>

The display control unit 355 generates an evaluation result display screen that indicates the result of evaluation using evaluation video data, and causes the display unit 320 to display the evaluation result display screen.

FIG. 5 is an explanatory drawing illustrating an evaluation result display screen UD3 according to the present disclosure. As shown in FIG. 5, the evaluation result display screen UD3 includes a comparison display D1 that is an example of first display information. The comparison display D1 includes a labeler tag E2 attached by the labeler U2 and a model tag E1 attached on the basis of the learned model, the labeler and model tags being disposed on the same time line of evaluation video data.

For example, in the comparison display D1, the labeler U2 can confirm a combination of the model tag E1 attached on the basis of the learned model and the labeler tag E2 attached by the labeler U2. The labeler U2 then corrects the labeler tag E2 attached to the evaluation video data, with reference to the model tag E1. For example, the labeler U2 may correct the labeler tag E2 according to the model tag E1 attached on the basis of the learned model. This can reduce variations in the policy of correction among labelers U2.

For example, the labeler U2 may correct the labeler tag E2 by changing the information tag or the position or width of a segment to be attached with the information tag.

When correcting the labeler tag E2, the labeler U2 may specify, as a target area, an area assumed to be highly relevant to a work in the overall area of the evaluation video data in the Crop information display field C8 of FIG. 3. This can improve the accuracy of the learned model.

If information about the working process is inputted in advance by the labeler U2, the estimation unit 353 may estimate, as an exceptional segment, a segment irrelevant to the working process. More specifically, for example, if a work procedure manual is inputted as information about the working process, the estimation unit 353 may estimate, as an exceptional segment, a segment irrelevant to the work procedure manual. The display control unit 355 may cause the display unit 320 to display an exceptional segment estimated by the estimation unit 353, as a black section EX as illustrated in FIG. 5. Thus, the labeler U2 can recognize that the exceptional segment does not need to be attached with the labeler tag E2, thereby further improving the workability of the labeler U2.

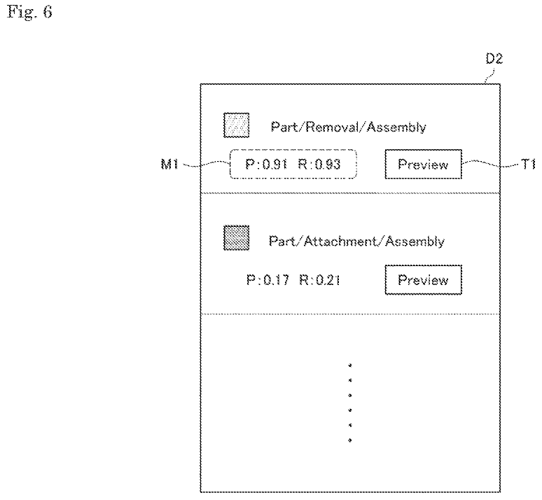

The comparison display according to the present disclosure was described above. Referring to FIG. 6, performance index display according to the present disclosure will be described below.

### <<4.4. Performance Index Display>>

On the basis of the evaluation video data and the learned model, the display control unit 355 may cause the display unit 320 to display a performance index as the result of estimation by the estimation unit 353. The performance index display is an example of second display information.

FIG. 6 is an explanatory drawing illustrating a performance index display D2 according to the present disclosure. The performance index display D2 according to the present disclosure includes an index M1 for the performance of the learned model.

For example, the index M1 for the performance of the learned model may be Precision (relevance factor) denoted as “P” or Recall (reproducibility) denoted as “R” as shown in FIG. 6. Alternatively, the index M1 may be an index for performance such as Accuracy (precision, accuracy rate) and Specificity (singularity).

The labeler U2 can quantitatively confirm the performance of the learned model by confirming an index M2 prepared for each information tag, thereby setting a criterion for improvement of the learned model.

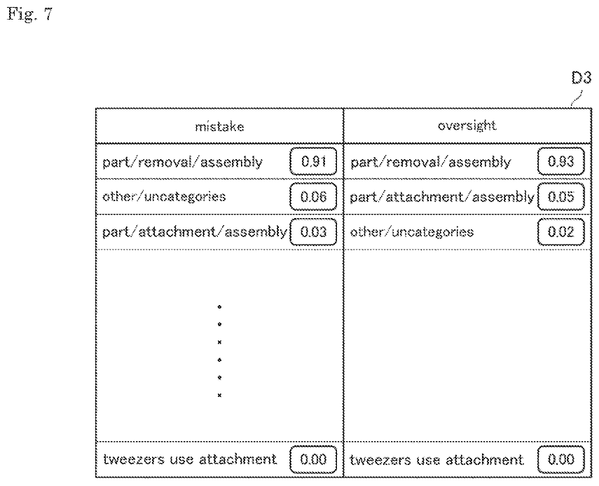

The display control unit 355 may cause the display unit 320 to display the detail of the performance index as details about the index M1. For example, when a Preview button T1 in FIG. 6 is selected, the display control unit 355 causes the display unit 320 to display the detail of the performance index. Referring to FIG. 7, an example of the detailed display of the performance index according to the present disclosure will be described below.

### <<4.5. Detailed Display of Performance Index>>

FIG. 7 is an explanatory drawing illustrating a detailed display D3 of the performance index according to the present disclosure. As shown in FIG. 7, the detailed display D3 of the performance index according to the present disclosure includes difference information about a model tag and a labeler tag. The detailed display D3 of the performance index is an example of third display information.

Regarding the index generated for the performance as the performance index display, the display control unit 355 may cause the display unit 320 to display difference information about the labeler tag attached by the labeler U2 and the model tag attached by the estimation unit 353. The labeler U2 can more specifically recognize a difference between the labeler tag and the model tag by confirming the detailed display D3 of the performance index, so that the display can be used as a guideline for correcting the labeler tag in the evaluation video data.

In FIG. 7, “mistake” corresponds to Precision while “oversight” corresponds to Recall. Usability can be improved by changing an index for performance such as Precision and Recall to a general term.

The example of the detailed display of the performance index according to the present disclosure was described above. With reference to the comparison display, the performance index display, or the detailed display of the performance index, the labeler U2 corrects the labeler tag of the evaluation video data when determining that the learned model needs to be improved. The learning unit 351 updates the learned model by relearning the evaluation video data with the corrected labeler tag as new teacher data. The estimation unit 353 then attaches the model tag again to the evaluation video data by using the updated learned model.

With reference to the comparison display, the performance index display, or the detailed display of the performance index, the labeler U2 may correct the labeler tag of the learning video data. The learning unit 351 can generate a learned model with higher accuracy by relearning the evaluation video data with the corrected labeler tag and the learning video data with the corrected labeler tag as new teacher data.

### (Inference Preparation)

When the labeler U2 determines that the learned model has reached desired performance, the estimation unit 353 attaches the model tag to video data to be inferred.

First, in order to perform inference, the labeler U2 selects the “Reserve Inference” button in FIG. 4. The labeler U2 then registers the imaging device 10 as a target of inference and a target date and time. At this point, inference may be made for a single target or a plurality of targets.

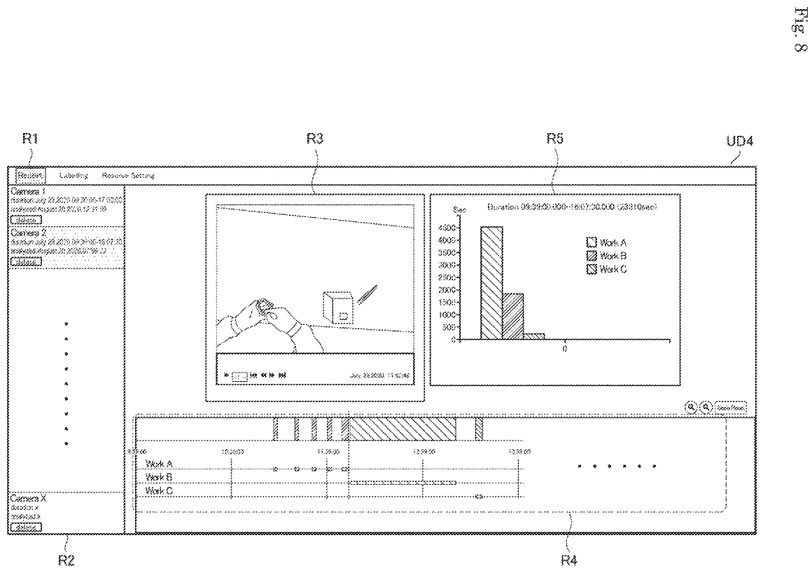

The estimation unit 353 then infers video data registered as a target of inference and outputs a report including the result of inference. Referring to FIG. 8, an example of an inference UI according to the present disclosure will be described below.

### <<4.6. Result of Inference>>

FIG. 8 is an explanatory drawing illustrating an example of a report display screen UD4 including the result of inference according to the present disclosure.

First, the labeler U2 selects the Report button R1 on the main category, so that the display unit 320 displays the report display screen UD4.

When the labeler selects a target of inference from an inference result list R2, the display unit 320 displays a display screen including video data R3 to be inferred, a determination result R4 of an information tag of the target of inference at each time, and a determination time R5 of each information tag in the target of inference.

For example, the estimation unit 353 attaches “Work A,” “Work B,” and “Work C” on the basis of the learned model. As the determination result R4 of the information tag in FIG. 8, the display unit 320 displays the display results of all model tags and each of the model tags on the same time line. By confirming the determination result R4 of the information tag, the labeler U2 can easily recognize, for example, a time when an anomaly has occurred.

As shown in FIG. 8, the determination time R5 of each information tag in a target of inference may be a bar chart including the time of each information tag determined by the estimation unit 353. By confirming the determination time R5 of each information tag, the labeler U2 can more intuitively recognize a working time for each work of the worker U1.

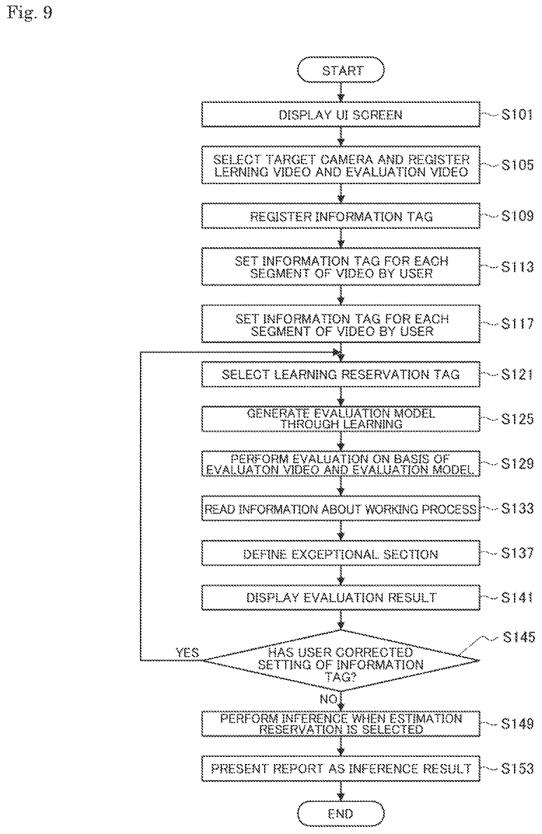

A specific example of the UI display screen according to the present disclosure was described above. Referring to FIG. 9, an operation processing example of the information processing device 30 according to the present disclosure will be described in sequence.

### 5. Operation Processing Example

FIG. 9 is an explanatory drawing for describing the operation processing example of the information processing device 30 according to the present disclosure. First, the display control unit 355 causes the display unit 320 to display the UI screen (S101).

Thereafter, a camera as a target of learning is selected by a user, and learning video data and evaluation video data are registered in the storage unit 340 (S105).

In the storage unit 340, an information tag is registered by the user (S109).

Subsequently, the information tag is attached to each segment of the learning video data by the user (S113).

The information tag is then attached to each segment of the evaluation video data by the user (S117).

Thereafter, a learning reservation tab is selected by the user (S121).

The learning unit 351 performs learning by using the learning video data with the information tag attached in S113, and generates a learned model (S125).

Thereafter, on the basis of the evaluation video data and the learned model, the estimation unit 353 performs an evaluation (S129).

The estimation unit 353 then reads information about a working process (S133).

Thereafter, the estimation unit 353 defines an exceptional segment on the basis of the read working process (S137).

The display control unit 355 causes the display unit 320 to display an evaluation result including the reflected exceptional segment (S141).

Subsequently, the information processing device 30 determines whether the labeler U2 has corrected the setting of the information tag (S145). If the setting of the information tag has been corrected (S145/Yes), the processing advances to S149. If the setting of the information tag has not been corrected (S145/No), the processing advances to S149.

If the setting of the information tag has not been corrected (S145/No), the estimation unit 353 infers video data for which an inference reservation is selected (S149).

The display control unit 355 causes the display unit 320 to display a report as the result of inference (S153), and then the information processing device 30 according to the present disclosure terminates the processing.

The operation processing example according to the present disclosure was described above. An example of an operation and an effect according to the present disclosure will be described below.

### 6. Example of Operation and Effect

According to the present disclosure, various operations and effects are obtained. For example, the information processing method according to the present disclosure provides the labeler U2 with display information including the labeler tag and the model tag, thereby improving the workability of an annotation work for modifying the learned model.

Moreover, the display unit 320 displays a segment not to be attached with an information tag, the segment being estimated according to the working process, so that the labeler U2 can easily recognize the segment of the information tag to be corrected when the learned model is improved.

### 7. Hardware Configuration Example

The overview of the embodiment of the present disclosure has been described above. The information processing is implemented by cooperation between software and the hardware of the information processing device 30, which will be described below. The following hardware configuration is also applicable to the imaging device 10 and the server 20.

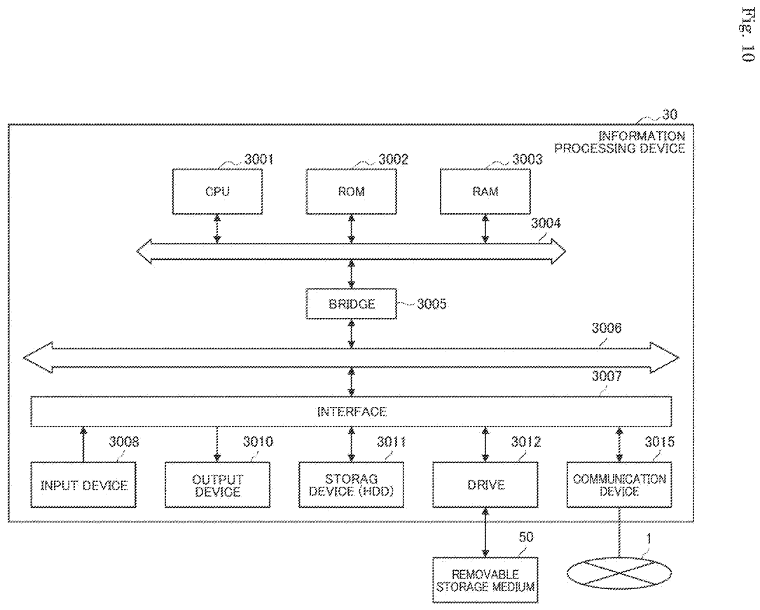

FIG. 10 is a block diagram illustrating the hardware configuration of the information processing device 30. The information processing device 30 includes a CPU (Central Processing Unit) 3001, a ROM (Read Only Memory) 3002, a RAM (Random Access Memory) 3003, and a host bus 3004. The information processing device 30 further includes a bridge 3005, an external bus 3006, an interface 3007, an input device 3008, an output device 3010, a storage device (HDD) 3011, a drive 3012, and a communication device 3015.

The CPU 3001 acts as an arithmetic processing unit and a controller and controls all operations in the information processing device 30 in accordance with various programs. The CPU 3001 may be a microprocessor. The ROM 3002 stores a program, an arithmetic parameter, and the like that are used by the CPU 3001. The RAM 3003 temporarily stores a program used in execution by the CPU 3001 or a parameter or the like that is appropriately changed during execution of the program. These units are connected to one other via the host bus 3004 including a CPU bus. Cooperation between the CPU 3001, the ROM 3002, and the RAM 3003 and software can implement the functions of the learning unit 351, the estimation unit 353, and the display control unit 355 that are described with reference to FIG. 2.

The host bus 3004 is connected to the external bus 3006 such as a PCI (Peripheral Component Interconnect/Interface) bus via the bridge 3005. The host bus 3004, the bridge 3005, and the external bus 3006 do not always need to be separated from one another. These functions may be implemented on a single bus.

The input device 3008 includes input means for inputting information by a user, the input means including a mouse, a keyboard, a touch panel, a button, a microphone, a switch, and a lever, and an input control circuit for generating an input signal on the basis of a user input and outputting the signal to the CPU 3001. A user of the information processing device 30 can input various kinds of data or provide an instruction of a processing operation to the information processing device 30 by manipulating the input device 3008.

The output device 3010 includes, for example, display devices such as a liquid crystal display device, an OLED device, and a lamp. Furthermore, the output device 3010 includes audio output devices such as speakers and headphones. The output device 3010 outputs, for example, reproduced contents. Specifically, the display device displays various kinds of information including reproduced image data, as text or images. The audio output device converts reproduced audio data or the like into a sound and outputs the sound.

The storage device 3011 is a device for storing data. The storage device 3011 may include a storage medium, a recording device for recording data on the storage medium, a reading device for reading data from the storage medium, and a deletion device for deleting data recorded on the storage medium. The storage device 3011 includes, for example, an HDD (Hard Disk Drive). The storage device 3011 drives a hard disk and stores a program executed by the CPU 3001 and various kinds of data.

The drive 3012 is a recording medium reader/writer and is contained in or externally attached to the information processing device 30. The drive 3012 reads information recorded on the removable storage medium 3018, e.g., a magnetic disk, an optical disc, a magneto-optical disc, or a semiconductor memory, which is mounted in the drive 3012, and outputs the information to the RAM 3003. Furthermore, the drive 3012 can write information on the removable storage medium 3018.

The communication device 3015 is, for example, a communication interface including a communication device or the like for connection to the network 1. The communication device 3015 may be a wireless LAN-compatible communication device, an LTE (Long Term Evolution)-compatible communication device, or a wire communication device that performs wire communications.

The hardware configuration example according to the present disclosure was described above. Supplements according to the present disclosure will be described below.

### 7. Supplements

Although the preferred embodiment of the present disclosure has been described in detail with reference to the accompanying drawings, the present disclosure is not limited to such examples. It is apparent that those having ordinary knowledge in the technical field of the present disclosure could conceive of various modified examples or changed examples within the scope of the technical ideas set forth in the claims, and it should be understood that these examples also naturally fall within the technical scope of the present disclosure.

For example, the functions of the devices included in the information processing system according to the present disclosure are merely exemplary. The information processing system according to the present disclosure is not limited to the example. For example, various kinds of learning for generating a learning model by the server 20 may be performed. The learned model generated by the server 20 is then acquired by the information processing device 30, and the learned model is transmitted to the imaging device 10 via, for example, OTA (On The Air) communications. On the basis of the received learned model, the imaging device 10 may perform inference on acquired video data. This can reduce the burden of the information processing device 30. Since each of the imaging devices 10 performs inference, processing can be performed at higher speeds than in inference by the information processing device 30 alone. The information processing device 30 may transmit, to the imaging device 10, a learned model converted to allow inference by the imaging device 10.

Moreover, on the basis of the learned model and an index indicating the skill of the worker U1, the estimation unit 353 according to the present disclosure may attach a model tag to the evaluation video data. Thus, the estimation unit 353 can attach a model tag in consideration of a working speed, which may vary according to the skill of the worker U1, and the working process.

In addition, the steps related to the processing of the information processing device 30 in the present specification do not necessarily have to be processed in chronological order in the order described in the flowchart. For example, the steps related to the processing of the information processing device 30 may be processed in an order different from the order described as the flowchart, or may be processed in parallel.

For example, a computer program for performing the same functions as the configurations of the imaging device 10, the server 20, and the information processing device 30 can be also created in hardware such as a CPU, ROM, and RAM in the imaging device 10, the server 20, and the information processing device 30. A storage medium in which the computer program is stored is also provided.

Furthermore, the effects described in the present specification are merely explanatory or exemplary and are not intended as limiting. That is, the techniques according to the present disclosure may exhibit other effects apparent to those skilled in the art from the description herein, in addition to or in place of the above effects.

The following configurations also fall within the technical scope of the present disclosure.

(1)

An information processing method performed by a computer, the method including: attaching a first information tag to a target segment of video data on the basis of the video data obtained by capturing a video of a worker and an evaluation model, the first information tag relating to a factory work; and generating first display information including a second information tag and the first information tag on the same time line of the video data, the second information tag relating to the factory work and being attached to a segment by a user, the first information tag being attached to the target segment.

(2)

The information processing method according to (1), further including: acquiring information about the working process of the worker; and estimating, on the basis of the information about the working process of the worker, a segment irrelevant to the working process in the video data as a segment not to be labeled, wherein the first display information includes information about the segment not to be labeled.

(3)

The information processing method according to (2), wherein the information about the working process includes information included in a work procedure manual prepared for each work in the factory.

(4)

The information processing method according to (2) or (3), wherein the information about the working process includes information about factory equipment used by the worker.

(5)

The information processing method according to any one of (1) to (4), further including generating second display information including an index for performance of the evaluation model, on the basis of the first information tag and the second information tag.

(6)

The information processing method according to (5), wherein the index for the performance of the evaluation model includes at least one of indexes indicating the relevance factor and reproducibility of the evaluation model.

(7)

The information processing method according to any one of (1) to (6), wherein the evaluation model is obtained by learning using a set of another video data obtained by capturing a video of the worker and a third information tag as teacher data, the third information tag being set by the user in a segment including the another video data.

(8)

The information processing method according to (7), wherein the evaluation model is relearned when the user corrects the video data or the second information tag in the display of the first display information.

(9)

The information processing method according to (7) or (8), wherein the evaluation model is obtained by learning using a set of a target area and the third information tag as teacher data, the target area being specified by the user in another video data obtained by capturing a video of the worker.

(10)

The information processing method according to any one of (5) to (9), further including generating, for the index for the performance of the evaluation model, third display information including difference information about the second information tag attached by the user and the first information tag attached by the evaluation model.

(11)

The information processing method according to any one of (7) to (10), wherein the evaluation model is obtained by learning of at least two pieces of the teacher data.

(12)

An information processing device including a control unit that attaches a first information tag to a target segment of video data on the basis of the video data obtained by capturing a video of a worker and an evaluation model, the first information tag relating to a factory work, and generates first display information including a second information tag and the first information tag on the same time line of the video data, the second information tag relating to the factory work and being attached to a segment by a user, the first information tag being attached to the target segment.

(13)

A program that causes a computer to implement
an attaching function of attaching a first information tag to a target segment of video data on the basis of the video data obtained by capturing a video of a worker and an evaluation model, the first information tag relating to a factory work; and
a generating function of generating first display information including a second information tag and the first information tag on the same time line of the video data, the second information tag relating to the factory work and being attached to a segment by a user, the first information tag being attached to the target segment.

### REFERENCE SIGNS LIST

1 Network
10 Imaging device
20 Server
30 Information processing device
310 Operation unit
320 Display unit
330 Communication unit
340 Storage unit
350 Control unit
351 Learning unit
353 Estimation unit
355 Display control unit

1. An information processing method performed by a computer, the method comprising: attaching a first information tag to a target segment of video data on a basis of the video data obtained by capturing a video of a worker and an evaluation model, the first information tag relating to a factory work; and
generating first display information including a second information tag and the first information tag on the same time line of the video data, the second information tag relating to the factory work and being attached to a segment by a user, the first information tag being attached to the target segment.

2. The information processing method according to claim 1, further comprising:
acquiring information about a working process of the worker; and
estimating, on the basis of the information about the working process of the worker, a segment irrelevant to the working process in the video data as a segment not to be labeled, wherein
the first display information includes information about the segment not to be labeled.

3. The information processing method according to claim 2, wherein the information about the working process includes information included in a work procedure manual prepared for each work in the factory.

4. The information processing method according to claim 3, wherein the information about the working process includes information about factory equipment used by the worker.

5. The information processing method according to claim 4, further comprising generating second display information including an index for performance of the evaluation model, on the basis of the first information tag and the second information tag.

6. The information processing method according to claim 5, wherein the index for the performance of the evaluation model includes at least one of indexes indicating the relevance factor and reproducibility of the evaluation model.

7. The information processing method according to claim 6, wherein the evaluation model is obtained by learning using a set of another video data obtained by capturing a video of the worker and a third information tag as teacher data, the third information tag being set by the user in a segment including the another video data.

8. The information processing method according to claim 7, wherein the evaluation model is relearned when the user corrects the video data or the second information tag in display of the first display information.

9. The information processing method according to claim 8, wherein the evaluation model is obtained by learning using a set of a target area and the third information tag as teacher data, the target area being specified by the user in another video data obtained by capturing a video of the worker.

10. The information processing method according to claim 9, further comprising generating, for the index for the performance of the evaluation model, third display information including difference information about the second information tag attached by the user and the first information tag attached by the evaluation model.

11. The information processing method according to claim 10, wherein the evaluation model is obtained by learning of at least two pieces of the teacher data.

12. An information processing device comprising a control unit that attaches a first information tag to a target segment of video data on a basis of the video data obtained by capturing a video of a worker and an evaluation model, the first information tag relating to a factory work, and generates first display information including a second information tag and the first information tag on the same time line of the video data, the second information tag relating to the factory work and being attached to a segment by a user, the first information tag being attached to the target segment.

13. A program that causes a computer to implement
an attaching function of attaching a first information tag to a target segment of video data on a basis of the video data obtained by capturing a video of a worker and an evaluation model, the first information tag relating to a factory work; and
a generating function of generating first display information including a second information tag and the first information tag on the same time line of the video data, the second information tag relating to the factory work and being attached to a segment by a user, the first information tag being attached to the target segment.
